(19) United States
(12) Patent Application Publication
(10) Pub. No.: US 2012/0305229 A1
(43) Pub. Date: Dec. 6, 2012

(54) HEAT EXCHANGER AND RELATED METHODS

(76) Inventor: DAVID M. STEVENS, SANDPOINT, ID (US)

(21) Appl. No.: 13/151,266

(22) Filed: Jun. 1, 2011

(51) Int. Cl. F28F 1/00; B23P 15/26; F16L 9/22

(52) U.S. Cl. 165/178; 138/155; 29/890.053

(57) ABSTRACT

A heat exchanger and related methods are provided. An example heat exchanger has moveable or flexible joints between tubular members that contain flowing heating medium. The moveable joints allow the overall structure of the heat exchanger to adapt to expansion, contraction, and other stresses of high-temperature, high thermal-gradient operation. The moveable joints also provide breaks in the structure, enabling repair or replacement of parts. A negative internal pressure is maintained to prevent flue gases and heat from escaping through the moveable joints, and prevents contamination of the ambient environment and products being dried. Moveable support measures also allow each tier of tubes to expand or contract independently of each other to accommodate thermal gradients within a given tier of tubes, within a given manifold, and between tiers of tubes, so that virtually all of the thermal stresses associated with conventional heat exchangers are mitigated or eliminated.

### BACKGROUND

Heat exchangers are used for many purposes, including drying of agricultural and forestry products, grasses, foods, hops; goods made from plant matter or animal products in a chamber, shed, or building.

Conventional joining techniques for metal tubing structures, such as heat exchangers and similar devices that must withstand high-temperature or high-thermal-gradient environments consist of welding, brazing, soldering, and similar assembly processes. These conventional techniques usually result in a rigid, monolithic structure that is relatively inflexible. Thermal stresses induced by the high-temperature and high-thermal-gradient environments reduce service life by causing material failure due to differential expansion, joinery failures due to thermal fatigue, etc. Once failure occurs, field service becomes very costly for maintenance, such as on-site welding, and often the entire unit must be removed in order to accomplish repairs.

In conventional heat exchangers that use a fluid exchange medium, the working-fluid is forced through an inlet of the device, creating a motive gradient that causes flow through the device toward an outlet. In the case of flue-gas heat exchangers, for example, this creates a condition where the flue gases inside the tubing of the device are at a higher operating pressure than the ambient-fluid (e.g., air) that is being heated, outside the tubing of the device. In the event of leakage in the heat exchanger's tubing or working-fluid path, potentially toxic flue gases may escape to be introduced into the air or other ambient-fluid. In certain circumstances, such as when drying of agricultural products or the like in a closed building, this escape of flue-gas can lead to contamination of the product being dried and an unsafe environment for human workers.

The conventional way to increase the safety of such devices is to use more expensive grades of metallic tubing and materials that are capable of operating in high-temperature environments. When flame impingement on metallic surfaces in direct-fired heat exchangers and similar devices occurs, however, the corrosion-resistant steels and even more exotic alloys are subject to significant corrosion and wear. Long-term exposure to such environments severely shortens the service life of these materials.

What is needed is a heat exchanger that is more resistant to high-temperature and high-thermal-gradient environments, and methods to maintain such heat exchangers at a much lower cost.

### SUMMARY

A heat exchanger and related methods are provided. An example heat exchanger has moveable or flexible joints between tubular members that contain flowing heating medium. The moveable joints allow the overall structure of the heat exchanger to adapt to expansion, contraction, and other stresses of high-temperature, high thermal-gradient operation. The moveable joints also provide breaks in the structure, enabling repair or replacement of parts. A negative internal pressure is maintained to prevent flue gases and heat from escaping through the moveable joints, and prevents contamination of the ambient environment and products being dried. Moveable support measures also allow each tier of tubes to expand or contract independently of each other to accommodate thermal gradients within a given tier of tubes, within a given manifold, and between tiers of tubes, so that virtually all of the thermal stresses associated with conventional heat exchangers are mitigated or eliminated.

This summary section is not intended to give a full description of an example heat exchanger and related methods. A detailed description with example implementations follows.

### BRIEF DESCRIPTION OF THE DRAWINGS

FIG. 1 is a diagram of an example dual path heat exchanger.

FIG. 2 is a diagram of an example single path heat exchanger.

FIG. 3 is a diagram of an example moveable joint between round tubing members.

FIG. 4 is a diagram of an example moveable joint between round and rectangular tubing members.

FIG. 5 is a flow diagram of an example method of constructing an example heat exchanger.

### DETAILED DESCRIPTION

### Overview

This disclosure describes heat exchangers and related methods. In one implementation, an example heat exchanger has moveable or flexible joints between tubular members that contain a flowing heating medium (“working-fluid”). Moveable, as used herein, means that connected members are allowed some play between each other, rather than a completely rigid conventional connection through welding and such means. Tube or tubular, as used herein, mean hollow or tube-like, to contain a flowing heating medium, such as heated air.

Tubular members connected at a moveable joint may be able to move longitudinally, transversally, rotationally, etc., with respect to each other. The moveable joints allow the overall structure of the heat exchanger to adapt to expansion, contraction, and other stresses of high-temperature, high thermal-gradient operation. In one implementation, the moveable joints allow hinge-like, rotational, and longitudinal (in-and-out) movements or play between tubular members of the heat exchanger during heating and cooling cycles. The moveable joints also provide breaks in the structure, enabling a way to dismantle the heat exchanger for repair or replacement of parts, without replacing the entire heat exchanger. This is preferable to conventional maintenance and repair of a permanently rigid and monolithic conventional structure, which is cumbersome. A conventional structure may be “totaled” if one section of the heat exchanger goes bad.

In conjunction with the moveable connection joints between tubular parts, an example heat exchanger may include a negative pressure system or device for moving a heating medium, such as hot air, through the example heat exchanger. Thus, a blower, vacuum pump, impeller (“vacuum device”), etc., may be connected to pull the fluid heating medium through the heat exchanger. Although the moveable connection joints are designed to provide a tight seal and to be leak-proof, maintaining an internal negative pressure with respect to the ambient environment being heated, aims to ensure that flue gases and heat do not leave from the example heat exchanger. This prevents contamination of the ambient environment, including both products being dried by the heat exchanger and humans. Negative-draft induction rather than a forced-draft system thus provides an additional benefit for the example heat exchanger.

While the moveable individual joints between adjoining tubes provide flexibility for thermal expansion and contraction, moveable support measures also allow each tier of working-fluid tubes to expand or contract independently of each other. Working in combination, this arrangement accommodates thermal gradients within a given tier of working-fluid tubes, within a given manifold, and between tiers of tubes; so that virtually all of the thermal stresses associated with conventional heat exchangers are mitigated or eliminated.

In one implementation, a direct-fired implementation of the example heat exchanger uses refractory-lining in flame impingement areas (areas of direct exposure to a flame and entrained particulates).

### Example System

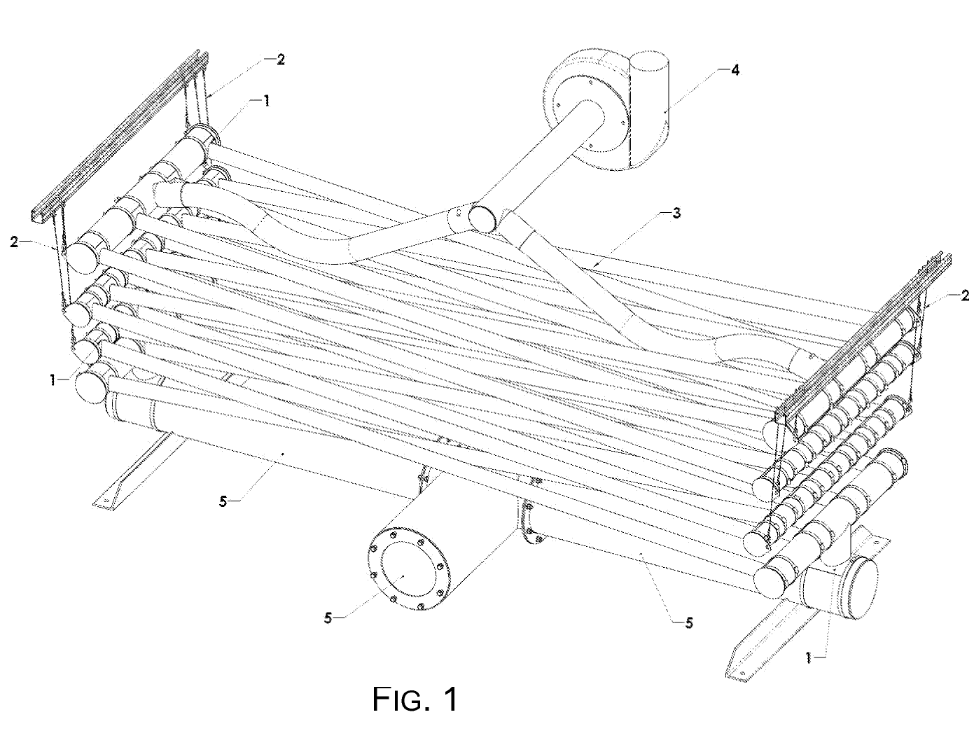

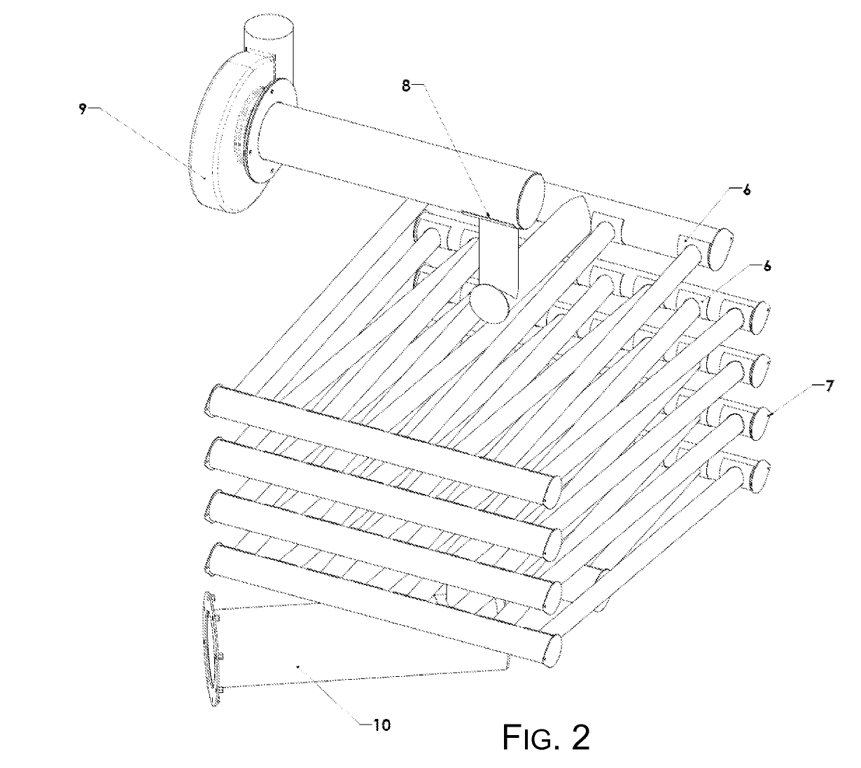

FIG. 1 shows one implementation of an example heat exchanger which provides a dual-path working-fluid flow. Various embodiments of the moveable tube connection joint 1, also shown in FIGS. 2-4, are utilized throughout the example heat exchanger structure. In one implementation, independent support hangers 2 are utilized for each intermediate manifold, thereby maintaining an innovative thermal expansion freedom. In this illustrated implementation, each manifold is suspended from above on cables 2; other implementations are also possible, such as rigid support pins that allow for unfettered thermal expansion/contraction, fixed shelf-like supports that allow for unfettered thermal expansion/contraction, etc. Flexible exhaust tubing 3 is used to attach the terminal exchanger manifolds to the example rigid induction fan inlet, maintaining freedom of thermal expansion/contraction. An induction fan 4 or other similar device is located at the outlet of the working-fluid path, providing the motive gradient to “pull” the working-fluid through the exchanger. An example direct-fire inlet 5 is refractory-lined in both the primary chamber and the primary inlet branches to protect the structure from flame corrosion and wear. Ambient air or other fluid-flow across the example heat exchanger can be in any direction. The preferred flow direction for the illustrated implementation is from top to bottom.

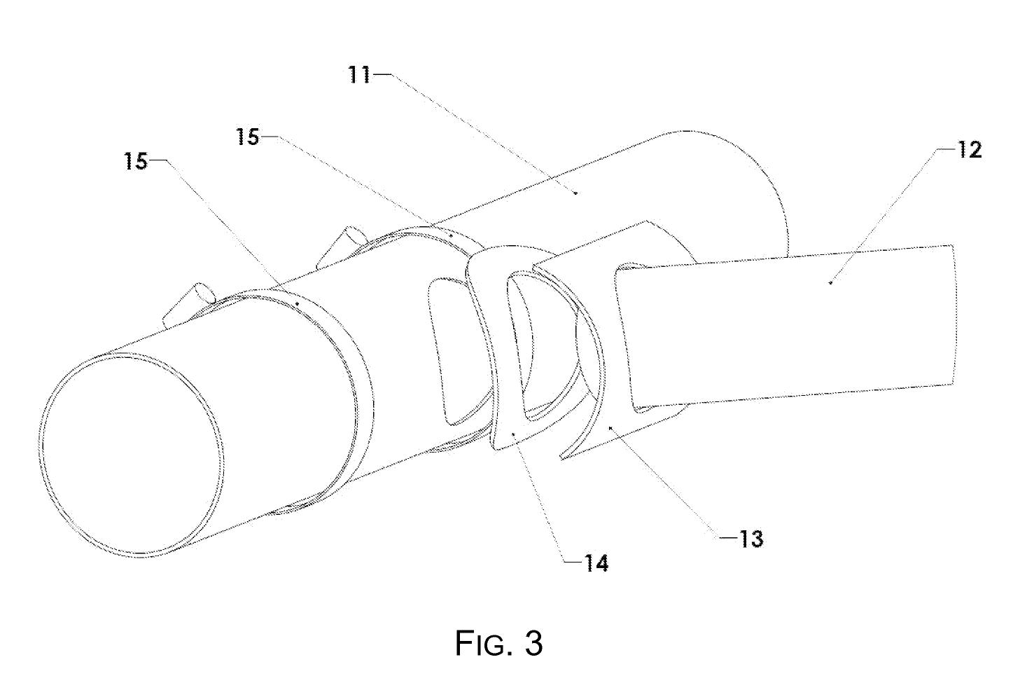

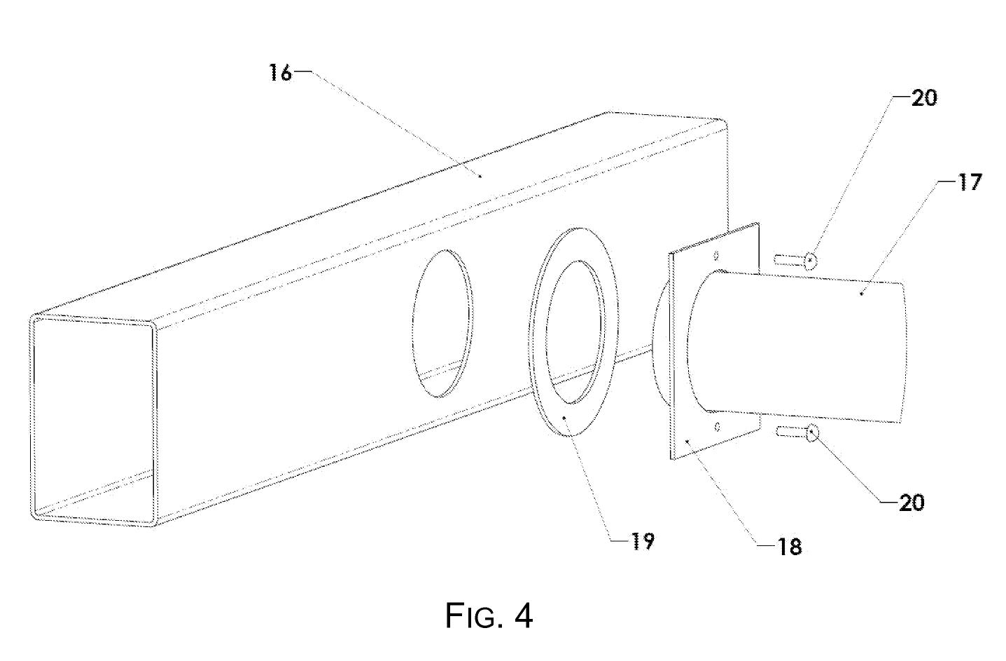

FIG. 2 shows another implementation of an example heat exchanger that provides a single-path working-fluid flow. As in FIG. 1, various implementations of the moveable connection joint 6, shown in greater detail in FIGS. 3-4, are utilized throughout the embodiment. Support pieces 7 are utilized to support each manifold in a condition to allow unfettered thermal expansion and contraction. An adequately flexible exhaust 8 is utilized to maintain freedom of thermal expansion and contraction. An induction fan 9 or other similar device is located at the outlet of the working-fluid path, providing the motive gradient to pull the working-fluid through the heat exchanger. The direct-fire inlet 10 is refractory lined to protect the structure from flame-impingement corrosion and wear. Ambient fluid flow across the example heat exchanger can be in any direction, the preferred direction for this implementation is from top to bottom.

FIG. 3 shows an example moveable connection joint. The manifold 11 is provided with a hole that is equal to or larger than the internal diameter of tube 12; in the illustrated version, the hole is slightly larger than the outside diameter of tube 12. The tube 12 is fitted with a flange 13, which may be affixed to the tube 12 via welding, brazing, soldering, mechanical attachments, etc. The flange 13 is formed to conform to a mating profile of the manifold 11. A short portion of the tube 12 may be left to extend beyond the flange 13 depending on the hole in the manifold 11. An optional high-temperature gasket 14 may be fitted between the manifold 11 and the flange 13; this gasket may be a dry material or a wet-applied material depending on the specific application. Mechanical clamps 15 may be utilized to hold the flange 13 snugly against the manifold 11, providing a seal for the working-fluid but maintaining thermal accommodation and field serviceability.

FIG. 4 shows another example moveable connection joint. The manifold 16 is provided with a hole that is equal to or larger than the internal diameter of tube 17. The tube 17 is fitted with a flange 18, which may be affixed to the tube 17 via welding, brazing, soldering, mechanical attachment measures, etc. The flange 18 is formed to conform to a mating profile of the manifold 16. A short portion of the tube 17 may be left to extend beyond the flange 18 depending on the hole in the manifold 16. An optional high-temperature gasket 19 may be fitted between the manifold 16 and the flange 18; this gasket may be a dry material or a wet-applied material depending on the specific application. Mechanical fasteners 20 may be utilized to hold the flange 18 snugly against the manifold 16, providing a seal for the working-fluid but maintaining thermal accommodation and field-serviceability.

In either implementation of the moveable tube connection joint illustrated in FIGS. 3-4, mechanical flexibility for adapting to thermal expansion and contraction is maintained through clamps and mechanical fasteners in lieu of rigid welds and other common conventional techniques. When the example heat exchanger undergoes thermal expansion or contraction, the flange-to-tube interface has some give that allows for movement of the joint while still maintaining a seal. The movement of individual joints is further enabled by the moveable manifold support measures, i.e., hanger 2 and support piece 7, described in FIGS. 1-2.

While the moveable individual joints between adjoining tubes provide flexibility for thermal expansion and contraction, moveable support measures also allow each tier of working-fluid tubes to expand or contract independently of each other. Working in combination, this arrangement accommodates thermal gradients within a given tier of working-fluid tubes, within a given manifold, and between tiers of tubes; so that virtually all of the thermal stresses associated with conventional heat exchangers are mitigated or eliminated.

### Example Methods

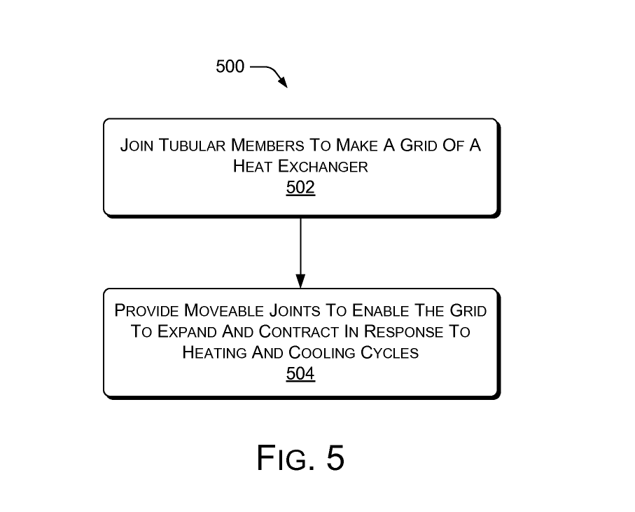

FIG. 5 is an example method 500 of constructing a heat exchanger. In the flow diagram, the operations are summarized in individual blocks.

At block 502, tubular members are joined to make a grid of a heat exchanger.

At block 504, moveable joints are provided to accomplish the joining. The moveable joints enable the grid to expand and contract in response to heating and cooling cycles.

### CONCLUSION

Features of the implementations described can be combined in different configurations within the scope of the subject matter. Thus, while there have been shown and described fundamental novel features as applied to the example implementations thereof, various omissions, substitutions, and changes in the form and detail of devices illustrated, and in their operation, may be made by those skilled in the art without departing from the spirit of the description. Elements and techniques shown and described in connection with any disclosed form or implementation of the example heat exchanger may be incorporated in any other disclosed, suggested, or described form or implementation as a general matter of design choice.

Although exemplary systems and methods have been described in language specific to structural features or techniques, the subject matter defined in the appended claims is not necessarily limited to the specific features or acts described. Rather, the specific features and acts are disclosed as example forms of implementing the claimed systems, methods, and structures.

1. An apparatus, comprising:
tubular members for containing a flowing heating medium;
moveable joints between the tubular members for accommodating thermal expansion and contraction of the apparatus and the tubular members.

2. The apparatus of claim 1, wherein the moveable joints enable an overall structure of the apparatus to adapt to expansion, contraction, and stresses of high-temperature, high thermal-gradient operation.

3. The apparatus of claim 1, wherein the moveable joints allow longitudinal, transversal, and rotational movement of the tubular members with respect to each other.

4. The apparatus of claim 1, wherein the moveable joints eliminate thermal stresses in the apparatus, including:
wherein the moveable joints enable tubular members within a given tier of the tubular members to expand or contract independently of each other to accommodate thermal gradients;
wherein the moveable joints enable independent movement between one or more tubular members and a manifold of the apparatus; and
wherein the moveable joints enable movement between different tiers of the tubular members.

5. The apparatus of claim 1, further comprising a vacuum device to create a negative internal pressure in the apparatus with respect to an external ambient pressure.

6. The apparatus of claim 5, wherein the vacuum device pulls the flowing heating medium through the apparatus to an outlet.

7. The apparatus of claim 1, further comprising a refractory lining on an interior surface of at least part of the apparatus to shield at least a tubular member from flame impingement.

8. The apparatus of claim 1, further comprising moveable external supports to moveably mount the apparatus to a surface.

9. An expandable heat exchanger, comprising:
multiple heating tubes connected with each other to carry a heating fluid; and
multiple flexible joints, each flexible joint flexibly connecting two of the heating tubes.

10. The expandable heat exchanger of claim 9, wherein an overall structure of the heat exchanger opens and closes, or unfolds and folds, in response to thermal gradients in the heat exchanger during heating and cooling cycles.

11. The expandable heat exchanger of claim 9, wherein each flexible joint enables heating tubes within a tier of the heat exchanger to expand or contract independently of each other in response to thermal gradients;
wherein the flexible joints enable independent movement between one or more of the heating tubes and a manifold of the heat exchanger; and
wherein the flexible joints enable movement between different tiers of the heating tubes.

12. The expandable heat exchanger of claim 9, further comprising a fluid impelling system to draw the heating fluid through the heat exchanger to an outlet.

13. The expandable heat exchanger of claim 12, wherein the fluid impelling system creates a negative internal pressure in the heat exchanger with respect to an external ambient pressure.

14. The expandable heat exchanger of claim 9, further comprising a refractory lining on an interior surface of at least a part of the heat exchanger to shield the part from flame impingement during heating.

15. The expandable heat exchanger of claim 9, further comprising moveable external supports to moveably mount the apparatus to a wall, ceiling, or floor.

16. The expandable heat exchanger of claim 9, wherein a flexible joint comprises a first heating tube protruding into an opening on a side of a second heating tube, the intersection of the two heating tubes stabilized with a flange.

17. A method, comprising:
joining tubular members to make a grid of a heat exchanger;
providing moveable joints between the tubular members to enable the grid to expand and contract in response to heating and cooling cycles.

18. The method of claim 17, further comprising:
providing a suction to draw a heated gas through the heat exchanger to prevent escape of the heated gas through the moveable joints.

19. The method of claim 17, further comprising mounting the heat exchanger with moveable supports to an immovable surface.

20. The method of claim 19, further comprising supporting different moveable parts of the heat exchanger with different moveable supports.
